(19) United States
(12) Patent Application Publication
(10) Pub. No.: US 2024/0311789 A1
(43) Pub. Date: Sep. 19, 2024

(54) SYSTEMS AND METHODS FOR EFFICIENT PRESENTATION OF PAYMENT OPTIONS AT POINT OF SALE DEVICES

(71) Applicant: JPMORGAN CHASE BANK, N.A., New York, NY (US)

(72) Inventors: Rasik GOYAL, Newark, DE (US); Nikunj TANNA, Newark, DE (US); Ashish P. AJMERA, Berkeley Heights, NJ (US); Sanjay DURGADIN, Hockessin, DE (US); Riti SINGHAL, Sayreville, NJ (US); Prashant G. PARANJAPE, Wilmington, DE (US); Selva DHARMARAJ, Wilmington, DE (US); Josh BERGER, Wilmington, DE (US); Tushar MISHRA, Bear, DE (US); Sean RODWELL-SIMON, Sewell, NJ (US); Shashank AITHALA, Newark, DE (US); Hari Kishore CHITNENI, Newark, DE (US); Lakshminarayana BAYAPAREDDY, Newark, DE (US); Rajendra HEBBATAM, Newark, DE (US)

(21) Appl. No.: 18/182,909

(22) Filed: Mar. 13, 2023

(51) Int. Cl. G06Q 20/20; G06Q 20/22; G06Q 20/34; G06Q 20/36

(52) U.S. Cl. CPC G06Q 20/204; G06Q 20/29; G06Q 20/351; G06Q 20/367; G06Q 2220/00

(57) ABSTRACT

Systems and methods for efficient presentation of payment options at point of sale devices are disclosed. A method may include: identifying a plurality of stored or provisioned payment cards in customer wallets for a merchant; (2) pre-qualifying each of the customers associated with the stored/provisioned payment cards for one or more installment payment options for a purchase from the merchant; and (3) communicating a list of token reference identifiers for stored/provisioned payment cards that have been pre-qualified and the one or more pre-qualified installment payment options to a merchant computer program executed by a merchant backend, wherein the merchant computer program receives a token reference identifier for a stored or provisioned payment card in one of the customer wallets, determines that the token reference identifier is on the list of pre-qualified token reference identifiers, and presents the one or more installment payment options in a checkout user interface.

### BACKGROUND OF THE INVENTION

### 1. Field of the Invention

Embodiments generally relate to systems and methods for efficient presentation of payment options at point of sale devices.

### 2. Description of the Related Art

It is common for third parties to offer financing to individuals making a purchase on a credit card. Because this financing is offered by a third party, the individual is required to submit to underwriting, which may include a credit check. And, once approved, the individual is required to pay the third party, not the credit card issuer, and possibly on a different payment schedule.

### SUMMARY OF THE INVENTION

Systems and methods for efficient presentation of payment options at point of sale devices are disclosed. According to one embodiment, a method for efficient presentation of payment options at point of sale devices may include: (1) identifying, by a financial institution computer program executed by a financial institution backend, a plurality of payment cards that have been stored in or provisioned to customer wallets for a merchant; (2) pre-qualifying, by the financial institution computer program, each of the customers associated with the stored or provisioned payment cards for one or more installment payment options for a purchase from the merchant; and (3) communicating, by the financial institution computer program, a list of token reference identifiers for stored or provisioned payment cards that have been pre-qualified and one or more pre-qualified installment payment options to a merchant computer program executed by a merchant backend, wherein the merchant computer program receives a token reference identifier for a stored payment card in one of the customer wallets, determines that the token reference identifier in the customer wallet is on the list of token reference identifiers that have been pre-qualified, and presents the one or more installment payment options associated with the token reference identifier in the customer wallet has been pre-qualified in a checkout user interface.

In one embodiment, the financial institution computer program may identify the plurality of payment cards that have been provisioned to customer wallets for the merchant by receiving provisioning messages from a payment network.

In one embodiment, the pre-qualified installment payment options may include a reduced interest rate for a period of time.

In one embodiment, the merchant computer program may access an offer database to retrieve the installment payment options.

In one embodiment, the method may also include receiving, from the merchant backend, a notification that one of the one or more installment payment options was accepted, wherein the notification comprises an identification of the accepted installment payment option and the token reference identifier.

In one embodiment, the method may also include consolidating, by the financial institution computer program, a plurality of accepted installment payment option offers for the same token reference identifier.

In one embodiment, the method may also include maintaining, by the financial institution computer program, the accepted installment payment option offer separately from other purchases made with the payment card.

According to another embodiment, a method for efficient presentation of payment options at point of sale devices may include: (1) receiving, by a merchant computer program executed by a merchant backend and from a financial institution backend, a list of token reference identifiers for payment cards that have been pre-qualified and one or more pre-qualified installment payment options for the token reference identifiers; (2) receiving, by the merchant computer program, a log in to a customer wallet with the merchant as part of a transaction; (3) retrieving, by the merchant computer program, a token reference identifier for a payment card that has been stored in or provisioned to the customer wallet; (4) determining, by the merchant computer program, that the token reference identifier in the customer wallet is on the list of token reference identifiers that have been pre-qualified; (5) retrieving, by the merchant computer program, the one or more pre-qualified installment payment options for the token reference identifier in the customer wallet; and (6) presenting, by the merchant computer program, the one or more pre-qualified installment payment options in a checkout user interface.

In one embodiment, the method may also include: receiving, by the merchant computer program, acceptance of one of the one or more pre-qualified installment payment options; notifying, by the merchant computer program, the financial institution backend of the acceptance by providing the token reference identifier and an identifier for the accepted pre-qualified installment payment option; and conducting, by the merchant computer program, a transaction.

In one embodiment, the transaction may be conducted over a payment network, and wherein the token reference identifier and the identifier for the accepted pre-qualified payment option may be provided over a network other than the payment network.

In one embodiment, the pre-qualified installment payment options may include a reduced interest rate for a period of time.

In one embodiment, the merchant computer program may retrieve the one or more pre-qualified installment payment options for the token reference identifier from an offer database.

In one embodiment, the merchant computer program may store the list of token reference identifiers for payment cards that have been pre-qualified and their one or more pre-qualified installment payment options in a token reference identifier database.

According to another embodiment, a system may include: a financial institution backend comprising a financial institution backend computer processor and executing a financial institution computer program that identifies a plurality of payment cards that have been stored in or provisioned to customer wallets for a merchant, pre-qualifies each of the customers associated with the stored in or provisioned payment cards for one or more installment payment options for a purchase from the merchant, and communicates a list of token reference identifiers for payment cards that have been pre-qualified and one or more pre-qualified installment payment options to a merchant computer program executed by a merchant backend; and a merchant backend comprising a merchant backend computer processor and executing a merchant program that receives a log in to a customer wallet with the merchant as part of a transaction, retrieves a token reference identifier for a payment card that has been stored in or provisioned to the customer wallet, determines that the token reference identifier in the customer wallet is on the list of token reference identifiers that have been pre-qualified, retrieves the one or more pre-qualified installment payment options for the token reference identifier, and presents the one or more pre-qualified installment payment options in a checkout user interface.

In one embodiment, the financial institution computer program may identify the plurality of payment cards that have been provisioned to customer wallets for the merchant by receiving provisioning messages from a payment network.

In one embodiment, the pre-qualified installment payment options may include a reduced interest rate for a period of time.

In one embodiment, the system may also include an offer database, and wherein the merchant computer program may access the offer database to retrieve the one or more pre-qualified installment payment options.

In one embodiment, the system may also include a payment network, and the merchant computer program may conduct the transaction over the payment network.

In one embodiment, the system may also include a second network, wherein merchant computer program may communicate the token reference identifier and the identifier for the accepted pre-qualified payment option to the financial institution backend over the second network.

In one embodiment, the financial institution computer program may consolidate a plurality of accepted installment payment option offers for the same token reference identifier.

### BRIEF DESCRIPTION OF THE DRAWINGS

For a more complete understanding of the present invention, the objects and advantages thereof, reference is now made to the following descriptions taken in connection with the accompanying drawings in which:

FIG. 1 illustrates a system for efficient presentation of payment options at point of sale devices according to an embodiment;

FIG. 2 illustrates a method for efficient presentation of payment options at point of sale devices according to an embodiment;

FIG. 3 depicts an exemplary computing system for implementing aspects of the present disclosure.

### DETAILED DESCRIPTION OF PREFERRED EMBODIMENTS

Embodiments are directed to efficient presentation of installment payment options at point of sale devices.

Embodiments may enable a customer of a financial institution to view and accept offers while shopping in person (e.g., at a point of sale device) or online at a merchant website and using a credit card that is provisioned to a customer wallet with a merchant to pay for a transaction. The offers may be, for example, for installment payments that allow the customer to pay over time. Other types of offers may be presented as is necessary and/or desired.

The customer may be able to accept the offer without having to submit a separate credit application. For example, for installment offers, the purchase may be seamlessly converted into an installment loan that may use the customer's line of credit on the credit card. The monthly due amount of the installment may be aggregated with the customer's existing credit card minimum payment due amount; the customer may not need to make or submit a separate payment for the installment loan. The customer may see and manage all of the customer's installment plans on, for example, a portal provided by a financial institution application or website.

Embodiments may proactively detect that the person shopping at a merchant is a customer of the financial institution and may determine eligibility for the offer as well as pricing based on the customer's existing data and does not require a new or separate credit application.

The data exchange between the merchant and the financial institution does not expose any Personal Identifiable Information (PII). For example, instead of using a credit card number, embodiments use the token reference identifier to identify the customer to the financial institution.

In embodiments, the installment plans may be automatically updated at the financial institution when the customer makes a return or merchant issues a credit.

Embodiments may combine the similar pricing and similar duration installment plans taken by a customer in a given period with a particular merchant. This approach keeps the number of installment plans to a manageable number and help customer see the big picture without heavy cognitive load.

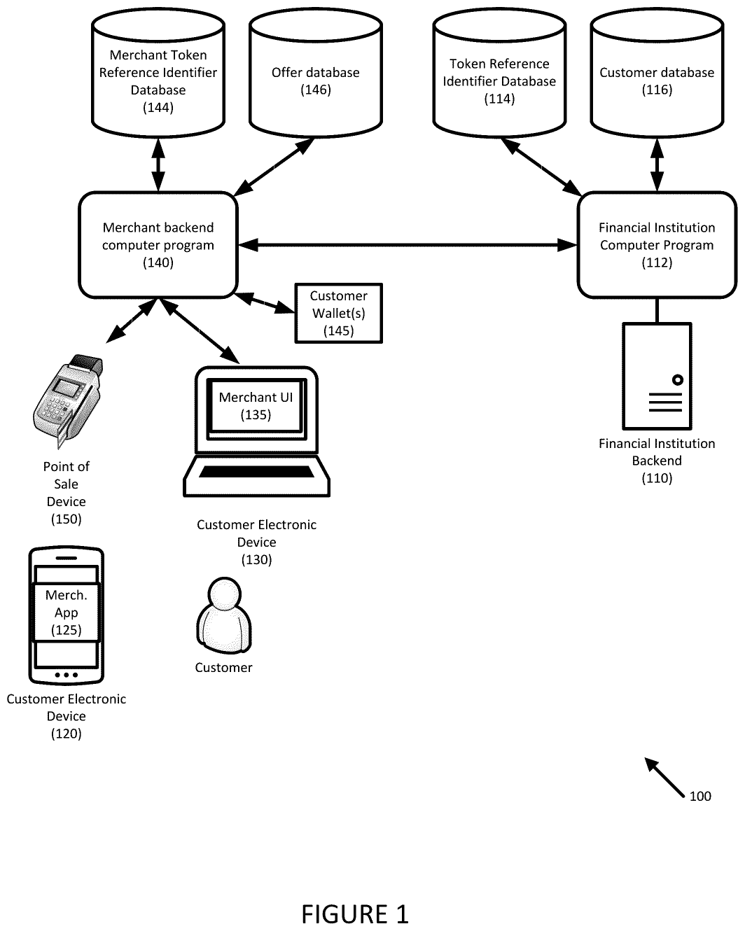

Referring to FIG. 1, a system for efficient presentation of payment options at point of sale devices is disclosed according to an embodiment. System 100 may include financial institution backed 110, which may include, for example, servers (e.g., physical and/or cloud-based), computers (e.g., workstations, desktops, laptops,), etc. Financial institution backend 110 may execute financial institution computer program 112, which may pre-qualify financial institution customers for installment payment offers.

Financial institution computer program 112 may access token reference identifier database 114, which may maintain an association between token reference identifiers for provisioned payment cards (e.g., credit cards, debit cards, etc.) and customers. In one embodiment, the token reference identifier may identify a payment token for an account (e.g., be an alias for the payment token). In one embodiment, the token reference identifiers may be provided by a payment network, by a third party, etc. as part of the provisioning process.

Financial institution computer program 112 may also access customer database(s) 116 which may maintain customer information that may be used to decision whether to offer an installment plan option to a customer. Customer database(s) 116 may be accessed by a decisioning engine (not shown) that may determine whether the customer is eligible for an offer, the type of offer, etc.

System 100 may also include merchant backend computer program 140 for a merchant. It should be noted that each merchant may have its own merchant backend computer program 140.

Merchant backend computer program 140 may receive a transaction from point of sale device 150 or merchant user interface 135 that may be executed by customer electronic device 130. For example, a customer may log in to customer wallet 145 with the merchant, using for example, merchant app 125 that may be executed by customer electronic device 120, in which one or more of the customer's payment cards have been provisioned or stored. In another embodiment, using merchant user interface 135 executed by customer electronic device 130, the customer may log in to a customer account with the merchant in which the customer has provisioned or stored payment cards.

Merchant backend computer program 140 may retrieve token reference identifiers for payment cards that the customer has provisioned to the customer wallet 145.

Merchant backend computer program 140 may maintain a listing of token reference identifiers and associated offers in merchant token reference identifier database 144. Merchant backend computer program 140 may receive the listing from financial institution computer program 112 and may store them in merchant token reference identifier database 144. After the customer has logged in, merchant backend computer program 140 may determine whether a token reference identifier that is received as part of the transaction is on the list stored in merchant token reference identifier database 144, and if it is, retrieve the offer associated with the token reference identifier. Merchant backend computer program 140 may then cause the offer to be presented on point of sale device 150 or merchant user interface 135.

In one embodiment, merchant backend computer program 140 may receive the offer to present from offer database 146, which may be updated periodically by financial institution computer program 112.

The customer may accept the offer, in which case the merchant backend computer program 140 may conduct the transaction with the presented credit card and may inform the financial institution computer program of the acceptance. From the merchant's perspective, there are no changes in the authorization or settlement process.

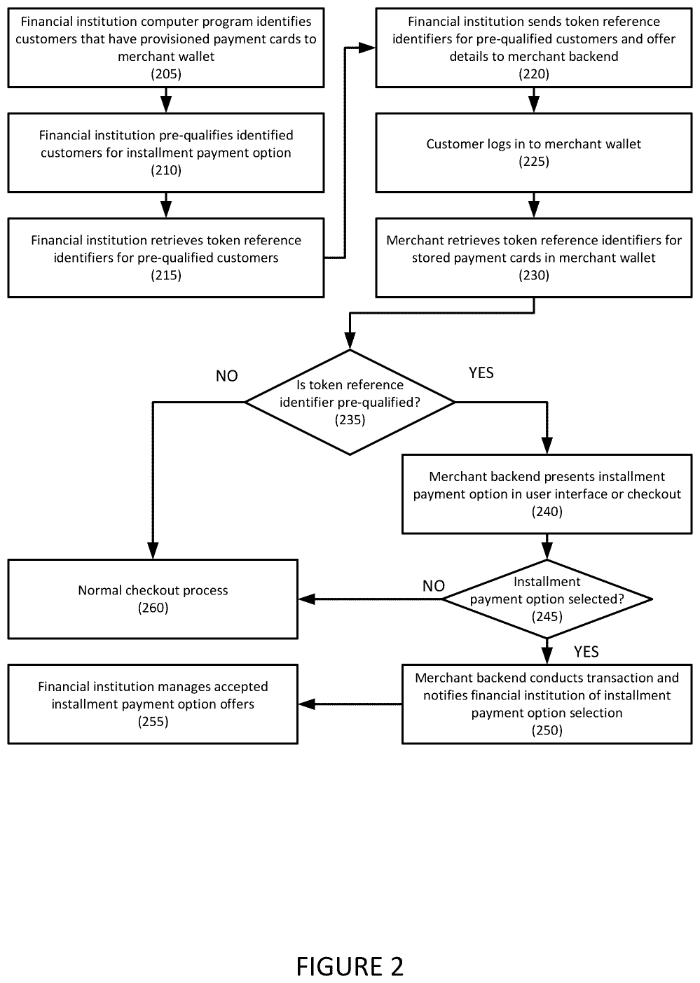

Referring to FIG. 2, a method for efficient presentation of payment options at point of sale devices is disclosed according to an embodiment.

In step 205, a financial institution computer program executed by a financial institution backend may identify customers that have provisioned payment cards, such as credit cards, debit cards, etc. to customer wallets with the merchant. For example, the financial institution computer program may maintain a list of credit cards that have been provisioned to customer wallets with the merchant.

For example, a financial institution may receive a provisioning message from a payment network when the customer first time adds a card to the customer wallet. Using this message, the financial institution may populate a list which has cross references to full card number to the tokens, merchant and token reference ids, etc. The addition of a card to this list is an indication that the customer intends to shop on an ongoing basis at a particular merchant, and may trigger a backend process where the financial institution shares offers for the particular customer with the specific merchant so that next time when customer shops with the merchant, the customer will be presented with installment payment option offers.

In step 210, the financial institution may pre-qualify the identified customers for one or more installment payment options for purchases from the merchant. Any suitable pre-qualification process may be used as is necessary and/or desired.

In one embodiment, the offers for the installment payment option may vary based on customer line of credit, customer payment history, length of customer relationship, etc. The offers may vary by length of offer, interest rate, etc.

In step 215, the financial institution may retrieve token reference identifiers for the provisioned credit cards that have been pre-qualified for offers. In one embodiment, the token reference identifiers are associated with the credit cards but do not include the credit card number.

In step 220, the financial institution may send the token reference identifiers that have been pre-qualified for an offer, and their associated offer(s), to the merchant backend. The token reference identifiers and associated offer(s) may be sent individually, or they may be sent in bulk. The token reference identifiers and associated offer(s) may also be sent periodically (e.g., hourly, daily, weekly, etc.) or as otherwise necessary and/or desired.

In step 225, a customer may log in to a customer wallet with the merchant. For example, the customer may log into an application that is associated with stored or provisioned payment instruments, may log in to a merchant account, etc.

In step 230, the merchant backend may retrieve the token reference identifiers for all stored or provisioned payment instruments in the customer wallet with the merchant.

In step 235, the merchant backend may compare the tokens reference identifiers for the stored or provisioned payment cards in the customer wallet with the list of token reference identifiers that have been pre-qualified for offers that was provided by the financial institution. If one or more of the token reference identifiers in the customer wallet matches of the token references received from the financial institution, in step 240, the merchant backend may retrieve the offer(s) associated with the token reference identifier and may present the offer(s) to the customer in a user interface or checkout screen. For example, the offer(s) may be presented on the screen of a point of sale device, or it may be presented in an online checkout flow.

In one embodiment, the merchant point of sale device or backend executing the checkout flow may access an offer database that the merchant may maintain locally to retrieve the offer details for the token reference identifier.

In step 245, if the customer selects the offer, in step 250, the merchant backend may conduct the transaction and notify the financial institution of the acceptance of the installment payment option. For example, the merchant may provide an identifier for the accepted payment option and the token reference identifier. The notification may be provided over a network other than the payment network, such as the Internet.

The merchant process settlement process may be otherwise unchanged. For example, the merchant may conduct the transaction over a payment network as per standard procedures.

In step 255, the financial institution may manage the accepted installment payment option offers. For example, the financial institution may maintain the accepted installment payment options separately from other purchases and present them to the user separately. In one embodiment, the financial institution may consolidate accepted installment payment option offers that have similar terms (e.g., interest rate, duration, etc.) into a single package.

As payments to the credit card account are received, the amount due on the accepted payment option offers may be paid first, and the remaining balance may be used to pay the revolving credit balance.

In step 230, if none of the token reference identifiers in the customer wallet matches one of the token references received from the financial institution, or in step 245 the customer does not select the offer, in step 260, the merchant backend may conduct the transaction as usual.

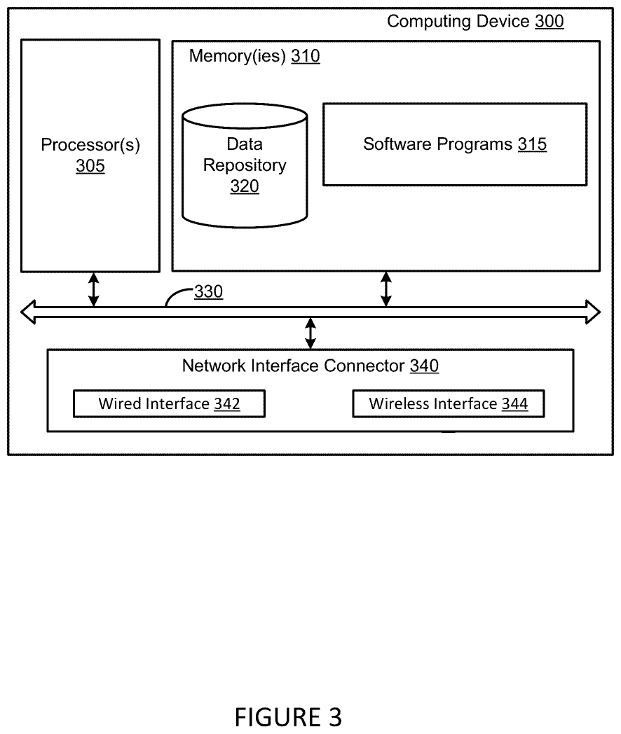

FIG. 3 depicts an exemplary computing system for implementing aspects of the present disclosure. FIG. 3 depicts exemplary computing device 300. Computing device 300 may represent the system components described herein. Computing device 300 may include processor 305 that may be coupled to memory 310. Memory 310 may include volatile memory. Processor 305 may execute computer-executable program code stored in memory 310, such as software programs 315. Software programs 315 may include one or more of the logical steps disclosed herein as a programmatic instruction, which may be executed by processor 305. Memory 310 may also include data repository 320, which may be nonvolatile memory for data persistence. Processor 305 and memory 310 may be coupled by bus 330. Bus 330 may also be coupled to one or more network interface connectors 340, such as wired network interface 342 or wireless network interface 344. Computing device 300 may also have user interface components, such as a screen for displaying graphical user interfaces and receiving input from the user, a mouse, a keyboard and/or other input/output components (not shown).

Although several embodiments have been disclosed, it should be recognized that these embodiments are not exclusive to each other, and features from one embodiment may be used with others.

Hereinafter, general aspects of implementation of the systems and methods of embodiments will be described.

Embodiments of the system or portions of the system may be in the form of a “processing machine,” such as a general-purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

In one embodiment, the processing machine may be a specialized processor.

In one embodiment, the processing machine may be a cloud-based processing machine, a physical processing machine, or combinations thereof.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement embodiments may be a general-purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA (Field-Programmable Gate Array), PLD (Programmable Logic Device), PLA (Programmable Logic Array), or PAL (Programmable Array Logic), or any other device or arrangement of devices that is capable of implementing the steps of the processes disclosed herein.

The processing machine used to implement embodiments may utilize a suitable operating system.

It is appreciated that in order to practice the method of the embodiments as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above, in accordance with a further embodiment, may be performed by a single component. Further, the processing performed by one distinct component as described above may be performed by two distinct components.

In a similar manner, the memory storage performed by two distinct memory portions as described above, in accordance with a further embodiment, may be performed by a single memory portion. Further, the memory storage performed by one distinct memory portion as described above may be performed by two memory portions.

Further, various technologies may be used to provide communication between the various processors and/or memories, as well as to allow the processors and/or the memories to communicate with any other entity; i.e., so as to obtain further instructions or to access and use remote memory stores, for example. Such technologies used to provide such communication might include a network, the Internet, Intranet, Extranet, a LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of embodiments. The set of instructions may be in the form of a program or software. The software may be in the form of system software or application software, for example. The software might also be in the form of a collection of separate programs, a program module within a larger program, or a portion of a program module, for example. The software used might also include modular programming in the form of object-oriented programming. The software tells the processing machine what to do with the data being processed.

Further, it is appreciated that the instructions or set of instructions used in the implementation and operation of embodiments may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments. Also, the instructions and/or data used in the practice of embodiments may utilize any compression or encryption technique or algorithm, as may be desired. An encryption module might be used to encrypt data. Further, files or other data may be decrypted using a suitable decryption module, for example.

As described above, the embodiments may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in embodiments may take on any of a variety of physical forms or transmissions, for example. Illustratively, the medium may be in the form of a compact disc, a DVD, an integrated circuit, a hard disk, a floppy disk, an optical disc, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors.

Further, the memory or memories used in the processing machine that implements embodiments may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the systems and methods, a variety of “user interfaces” may be utilized to allow a user to interface with the processing machine or machines that are used to implement embodiments. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method, it is not necessary that a human user actually interact with a user interface used by the processing machine. Rather, it is also contemplated that the user interface might interact, i.e., convey and receive information, with another processing machine, rather than a human user. Accordingly, the other processing machine might be characterized as a user. Further, it is contemplated that a user interface utilized in the system and method may interact partially with another processing machine or processing machines, while also interacting partially with a human user.

It will be readily understood by those persons skilled in the art that embodiments are susceptible to broad utility and application. Many embodiments and adaptations of the present invention other than those herein described, as well as many variations, modifications and equivalent arrangements, will be apparent from or reasonably suggested by the foregoing description thereof, without departing from the substance or scope.

Accordingly, while the embodiments of the present invention have been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications or equivalent arrangements.

What is claimed is:

1. A method for efficient presentation of payment options at point of sale devices, comprising:
identifying, by a financial institution computer program executed by a financial institution backend, a plurality of payment cards that have been stored in or provisioned to customer wallets for a merchant;
pre-qualifying, by the financial institution computer program, each of the customers associated with the stored or provisioned payment cards for one or more installment payment options for a purchase from the merchant; and
communicating, by the financial institution computer program, a list of token reference identifiers for stored or provisioned payment cards that have been pre-qualified and the one or more pre-qualified installment payment options to a merchant computer program executed by a merchant backend, wherein the merchant computer program receives a token reference identifier for a stored or provisioned payment card in one of the customer wallets, determines that the token reference identifier in the customer wallet is on the list of token reference identifiers that have been pre-qualified, and presents the one or more installment payment options associated with the token reference identifier in the customer wallet has been pre-qualified in a checkout user interface.

2. The method of claim 1, wherein the financial institution computer program identifies the plurality of payment cards that have been stored in or provisioned to customer wallets for the merchant by receiving provisioning messages from a payment network.

3. The method of claim 1, wherein the pre-qualified installment payment options comprise a reduced interest rate for a period of time.

4. The method of claim 1, wherein the merchant computer program accesses an offer database to retrieve the installment payment options.

5. The method of claim 1, further comprising:
receiving, from the merchant backend, a notification that one of the one or more installment payment options was accepted, wherein the notification comprises an identification of the accepted installment payment option and the token reference identifier.

6. The method of claim 1, further comprising:
consolidating, by the financial institution computer program, a plurality of accepted installment payment option offers for the same token reference identifier.

7. The method of claim 1, further comprising:
maintaining, by the financial institution computer program, the accepted installment payment option offer separately from other purchases made with the payment card.

8. A method for efficient presentation of payment options at point of sale devices, comprising:
receiving, by a merchant computer program executed by a merchant backend and from a financial institution backend, a list of token reference identifiers for payment cards that have been pre-qualified and one or more pre-qualified installment payment options for the token reference identifiers;
receiving, by the merchant computer program, a log in to a customer wallet with the merchant as part of a transaction;
retrieving, by the merchant computer program, a token reference identifier for a payment card that has been stored in or provisioned to the customer wallet;
determining, by the merchant computer program, that the token reference identifier in the customer wallet is on the list of token reference identifiers that have been pre-qualified;
retrieving, by the merchant computer program, the one or more pre-qualified installment payment options for the token reference identifier in the customer wallet; and
presenting, by the merchant computer program, the one or more pre-qualified installment payment options in a checkout user interface.

9. The method of claim 8, further comprising:
receiving, by the merchant computer program, acceptance of one of the one or more pre-qualified installment payment options;
notifying, by the merchant computer program, the financial institution backend of the acceptance by providing the token reference identifier and an identifier for the accepted pre-qualified installment payment option; and
conducting, by the merchant computer program, a transaction.

10. The method of claim 9, wherein the transaction is conducted over a payment network, and wherein the token reference identifier and the identifier for the accepted pre-qualified payment option are provided over a network other than the payment network.

11. The method of claim 8, wherein the pre-qualified installment payment options comprise a reduced interest rate for a period of time.

12. The method of claim 8, wherein the merchant computer program retrieves the one or more pre-qualified installment payment options for the token reference identifier from an offer database.

13. The method of claim 8, wherein the merchant computer program stores the list of token reference identifiers for payment cards that have been pre-qualified and the one or more pre-qualified installment payment options in a token reference identifier database.

14. A system, comprising:
a financial institution backend comprising a financial institution backend computer processor and executing a financial institution computer program that identifies a plurality of payment cards that have been stored in or provisioned to customer wallets for a merchant, pre-qualifies each of the customers associated with the stored in or provisioned payment cards for one or more installment payment options for a purchase from the merchant, and communicates a list of token reference identifiers for payment cards that have been pre-qualified and the one or more pre-qualified installment payment options to a merchant computer program executed by a merchant backend; and
a merchant backend comprising a merchant backend computer processor and executing a merchant program that receives a log in to a customer wallet with the merchant as part of a transaction, retrieves a token reference identifier for a payment card that has been stored in or provisioned to the customer wallet, determines that the token reference identifier in the customer wallet is on the list of token reference identifiers that have been pre-qualified, retrieves the one or more pre-qualified installment payment options for the token reference identifier, and presents the one or more pre-qualified installment payment options in a checkout user interface.

15. The system of claim 14, wherein the financial institution computer program identifies the plurality of payment cards that have been stored in or provisioned to customer wallets for the merchant by receiving provisioning messages from a payment network.

16. The system of claim 14, wherein the pre-qualified installment payment options comprise a reduced interest rate for a period of time.

17. The system of claim 14, further comprising an offer database, and wherein the merchant computer program accesses the offer database to retrieve the one or more pre-qualified installment payment options.

18. The system of claim 14, further comprising a payment network, and the merchant computer program conducts the transaction over the payment network.

19. The system of claim 18, further comprising a second network, wherein merchant computer program communicates the token reference identifier and the identifier for the accepted pre-qualified payment option to the financial institution backend over the second network.

20. The system of claim 14, wherein the financial institution computer program consolidates a plurality of accepted installment payment option offers for the same token reference identifier.
